(19) United States
(12) Patent Application Publication
(10) Pub. No.: US 2019/0251809 A1
(43) Pub. Date: Aug. 15, 2019

(54) Modular Pucks for Retail Security System

(71) Applicant: Mobile Tech, Inc., Lake Oswego, OR (US)

(72) Inventors: Wade Wheeler, Lake Oswego, OR (US); Robert Logan Blaser, Lake Oswego, OR (US)

(21) Appl. No.: 16/271,517

(22) Filed: Feb. 8, 2019

Related U.S. Application Data
(60) Provisional application No. 62/628,885, filed on Feb. 9, 2018.

(51) Int. Cl. G08B 13/14; G06F 13/38

(52) U.S. Cl. CPC G08B 13/1463; G06F 2213/0042; G06F 13/382; G08B 13/1418

(57) ABSTRACT

This disclosure relates to retail security systems for use with attached electronic products. The retail security system may have a plurality of pucks to attach to least one electronic product and interconnected by connective modules to form the retail security system. The pucks can be modular pucks to form a modular retail security system. Through a cabled connection, the electronic products connect to the modular retail security system thereby providing power and alarming security for the connected electronic product. The modular retail security system may have interactive network elements to communicate wired or wirelessly with a remote computer system. The remote computer system may track the connected electronic products. The modular retail security system may also track and maintain the alarming status of the connected electronic products or the overall operational health of the modular pucks.

### CROSS-REFERENCE AND PRIORITY CLAIM TO RELATED APPLICATIONS:

This patent application claims priority to U.S. provisional patent application Ser. No. 62/628,885, filed Feb. 9, 2018, entitled “Systems and Methods for Retail Security”, the entire disclosure of which is incorporated herein by reference.

This patent application is also related to (1) U.S. patent application Ser. No. ______, filed this same day, entitled “Systems and Methods for Modular Retail Security” (said patent application being identified by Thompson Coburn Attorney Docket Number 60977-182309), and (2) U.S. patent application Ser. No. ______, filed this same day, entitled “Control for Modular Retail Security System” (said patent application being identified by Thompson Coburn Attorney Docket Number 60977-182539), each of which claim priority to the '885 provisional patent application, and where the entire disclosures of each of which are incorporated herein by reference.

### INTRODUCTION

This disclosure relates generally to security systems, and, more particularly, modular retail security systems of attached devices.

In an example embodiment, the modular retail security system pucks are provided to attach at least one device to the modular retail security system. Through a cabled connection, the devices connect to the modular retail security system, thereby providing power and alarming security for the connected devices. The modular retail security system may have interactive network elements to communicate wired or wirelessly with a remote or connected computer system. The computer system may track the connected devices to determine a received device identifier for a specific device connected to the modular retail security system. Also, the computer system or the control module of the modular retail security system may track and maintain the alarming status of the connected devices or the overall operational health of the modular retail security system.

Further features and advantages of the disclosed embodiments, as well as the structure and operation of various elements of the disclosed embodiments, are described in detail below with reference to the accompanying drawings.

### BRIEF DESCRIPTION OF THE DRAWINGS

The accompanying drawings, which are incorporated in and form a part of the specification, illustrate the disclosed embodiments and together with the description, serve to explain certain inventive principles. In the drawings:

FIG. 1 shows a perspective view of a retail security system for an example embodiment.

FIG. 2 shows a perspective view of a control module of the retail security system of FIG. 1.

FIG. 3 shows assembly of a retail security system for an example embodiment.

FIG. 4 shows a linear design of the retail security system.

FIG. 5 shows a non-linear layout of the retail security system.

FIG. 6 is a linear layout of the modular retail security system along with color profile indicators of the light rings used with the modular pucks of the modular retail security system.

FIG. 7 shows a component diagram of an example modular puck.

FIG. 8A shows an example process flow for a modular puck with respect to processing input power.

FIG. 8B shows an example process flow for a modular puck with respect to processing input data.

FIG. 9 shows an example process flow for a modular puck with respect to obtaining and relaying information about a connected electronic device.

FIG. 10 shows a component diagram of an example control module.

FIG. 11A shows an example process flow for a control module with respect to receiving data from a remote computer system.

FIG. 11B shows an example process flow for a control module with respect to receiving data from a connected modular puck.

FIG. 12 shows an example retail security system where the control module includes multiple interfaces for connecting with multiple modular pucks.

FIG. 13 shows an example retail security system where a modular puck includes 4 or more interfaces for connecting with other components in the retail security system.

FIG. 14 shows an example retail security system where control and security functionality are combined in a puck that interfaces with one or more electronic devices.

### DETAILED DESCRIPTION OF EXAMPLE EMBODIMENTS

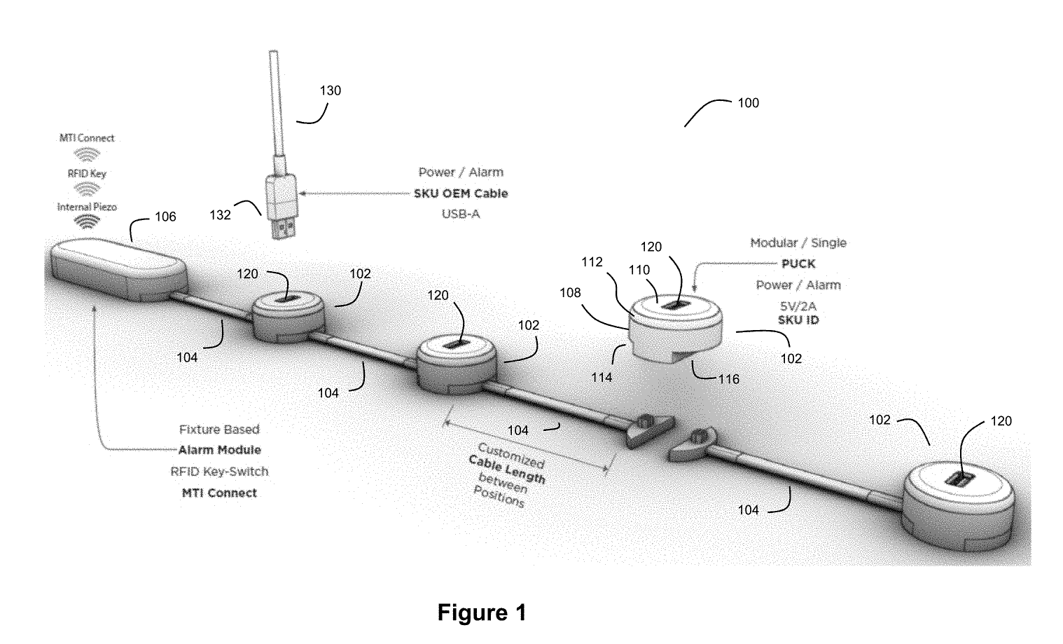

FIG. 1 is a perspective view of a retail security system 100 for an example embodiment. The retail security system 100 may have a plurality of pucks 102 arranged in a sequence and connected to connective modules 104. The retail security system 100 may also include a control module 106 for the sequence. The pucks 102 may be modular pucks as described below. Each individual modular puck 102 can be independently functional from the other modular pucks 102 of the modular retail security system 100. However, together the interconnected plurality of modular pucks 102 create the modular retail security system 100 along with any other interconnected components.

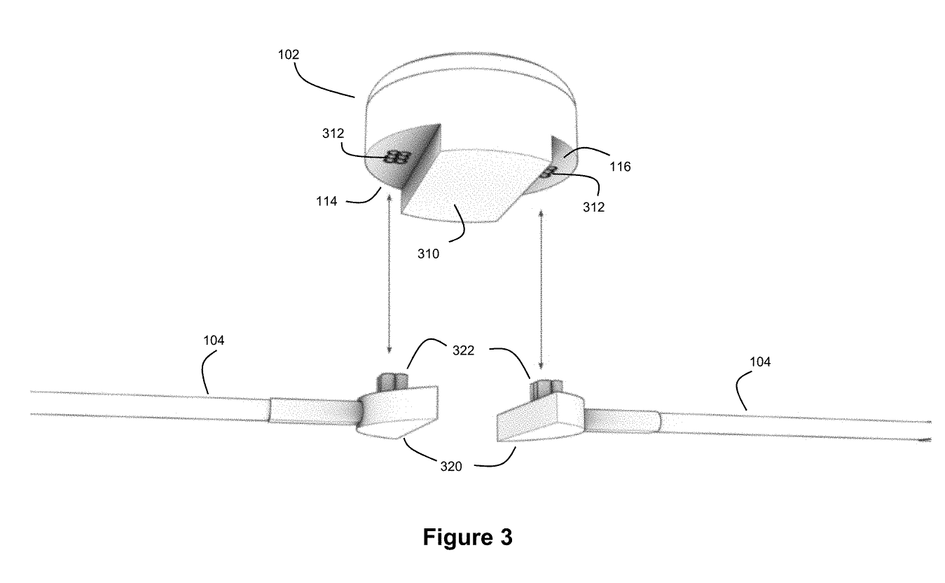

Each individual modular puck 102 may contain a housing 108 having an interior to store electronic components. The housing 108 may be made of any type of durable material so that simple jostling or movement of the housing 108 will not break or allow the housing to dislodge from its current position in a retail environment. For example, the housing 108 may be made of durable plastic polymer materials, but it should be understood that other materials of substantial structural strength may also be used. In the example of FIG. 1, the housing 108 has a generally short cylindrical profile along with a top face 110 and a bottom face 310 (see FIG. 3) of the housing 108. However, it should be understood that other shapes for the puck 102 could be employed. For example, the puck 102 could exhibit a taller cylindrical profile, a box shape, an oval or elliptical shape, a trapezoidal shape, or others.

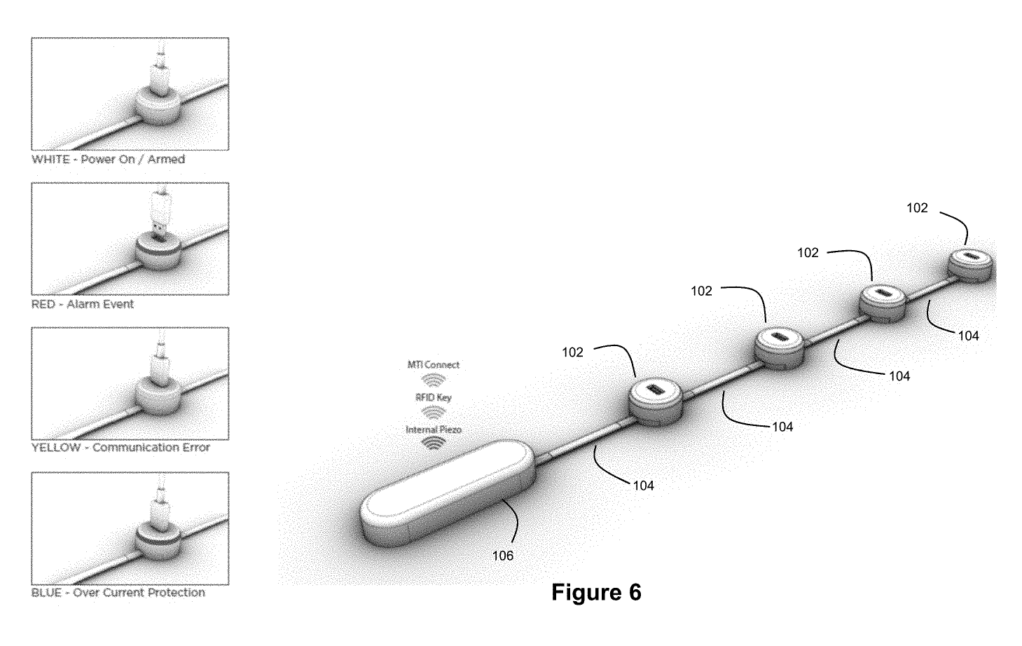

Below the top face 110 of the housing 108, a light ring 112 may be present. The light ring 112 circumscribes the housing shape. The light ring 112 may connect to internal circuitry housed within the individual modular puck 102 to power a plurality of lights, which may be but is not limited to light emitting diodes (LEDs) positioned around the light ring 112. Data/information signals can be communicated between the internal circuitry of the housing 108 and the plurality of lights to illuminate the light ring 112. Each light may have an on state and an off state. Based on the power and data/information transferred with these data/information signals, these states may change the illumination of the lights to show a retail employee or customer the status of the modular puck 102. In some embodiments, the plurality of LEDs may be different colors to represent different statuses of the individual puck. More information regarding examples of these statuses that can be used for the individual pucks 102 will be described below with FIG. 6.

Each individual modular puck 102 may also have a plurality of interfaces. These interfaces provide applicable means for both data/information transfer and power transfer between connected components. The plurality of interfaces may each connect to an internal circuit contained within the housing 108. This internal circuit may be contained on an electronic circuit board having microprocessors, buses, and other electronic interconnection components to facilitate data transfer and power between devices attached to the plurality of interfaces.

As an example of one of these interfaces on the modular puck 102, an interface 120 may be located on a surface of the modular puck's housing 108 such as the top face 110 of the housing 108. This interface 120 may be a cable input for a data and power transmission cable 130. An electronically connectable cable 130 may fit within the cable input interface 120 at one end 132 of the cable 130; and a second end of the cable 130 may be attached to an electronic product or device to secure the product or device to the modular puck 102 via the cable 130. The cable 130 may provide a path for data/information and power transfer between the electronic product and the modular puck 102. The cable 130 may also act as an alarming mechanism as removal of the cable 130 can trigger an alarm status for the individual puck 102 (and also trigger a corresponding alarming of the modular retail security system 100). These cables 130, in some examples, can have a USB interface (e.g., a USB-A interface, a USB-C interface, etc.) to connect to a corresponding USB interface of the cable input interface 120, but it should also be understand that different data and power transfer protocol interfaces may be used for these connections between the cable 130 and the cable input interface 120. The cable 130, in some embodiments, may be a stock keeping unit (SKU) provided by the original equipment manufacturer (OEM) of the connected electronic product or device. In such situations, this SKU OEM cable 130 would provide the maximum efficiency for data and power transfer between the electronic product and the individual modular puck as SKU OEM cables 13—are specifically rated for use with such devices. Also, by way of example, the electronic product or device connected to the puck 102 via cable 130 can be any of a number of different product or device types. For example, the electronic devices could be smart phones, tablet computers, wearables (e.g., smart watches, VR goggles/headsets, etc.), digital cameras, or other suitable item of merchandise that a practitioner wishes to secure via system 100.

Each individual puck 102 may also have interfaces 312 located on a bottom face 310 of the housing 108 (see FIG. 3). In the example of FIG. 1 (and FIG. 3), two such interfaces 312 are shown. As seen in FIG. 1, the bottom face of each modular puck 102 may have a unique configuration where a plurality of cutouts 114 and 116 are located on each side of the modular puck 102. The cutouts 114 and 116 provide the modular puck 102 with modular connectivity so that it can fit with other connective modules 104 of the modular retail security system 100. For example, each of these plurality of cutouts 114 and 116 may have a semi-circular shape to fit a corresponding shape of the connective module 104 which may attach to the modular puck 112. However, it should be understood that other shapes for the cutouts 114 and 116 could be employed (for example, rectangular cutouts, etc.). When connected to the modular puck 102, the connective modules 104 give the appearance of the modular puck 102 having a complete cylindrical design.

Contained within each of the plurality of cutouts 114 and 116 can be a connective mount interface 312 (see FIG. 3) which may travel through the bottom face 310 of the modular puck 102 and into the interior of the modular puck 102. These connective mount interfaces 312 may electronically connect to the interior circuitry of the modular puck 102 to allow the modular puck 102 to communicate data/information and power with any connective modules 104 or other modular pucks 102 within the modular retail security system 100. In an example embodiment, the connective mount interface 312 may have a pin configuration design; and in more specific embodiments, the connective mounts may have a 6-pin configuration design. The structure of this pin configuration allows the connective modules 104 to securely attach and remain within the modular puck 102 so that data information and power transfer is uninterrupted. It should be understood that other connective mount designs may be used along with implementing additional locking mechanisms to the housing 108 of the modular puck 102 to further secure the connective modules 104 within the modular puck 102. Additional views of these connective mount interfaces 312 may be seen in more detail with FIG. 3.

As stated above, each modular puck 102 may contain internal circuitry for operation within the modular retail security system 100. The internal circuitry may be contained on an electronic circuit board and allows data/information and power communication between the attached electronic product or device, the modular puck 102, and other attached modular pucks 102 or control modules 106 attached by the connective modules 104 in the modular retail security system 100. An example of such circuitry is described below, but it should be understood that many different layouts and designs of this internal circuitry may be used.

FIG. 8 shows a component diagram of an example modular puck 102. In this example, the internal circuitry includes a security module 702, an external output module 704, a communication module 706, and a power module 708. These modules may take the form of circuitry (including processors as may be appropriate) as discussed below. The modules can be interconnected with each other and with the interfaces 120 and 312. In the example of FIG. 8, the puck 102 includes a single interface 120 and two interfaces 312. However, it should be understood that additional interfaces 120 and 312 may be implemented in puck 102 if desired by a practitioner.

The security module 702 may be configured to provide security and alarm functions for the puck 102. Accordingly, the circuitry in module 702 may include sensors for detecting cable connections via interface 120 as well as detecting disconnections of electrical devices from connected cables 120. If desired by a practitioner, security module 702 may also include an audio output device such as a speaker that produced an audible alarm in the event of the puck 102 going into alarm status. Examples of circuitry that can be used by the modular pucks for security module 702 are described in (1) provisional U.S. Patent Application No. 62/553,770, filed Sep. 1, 2017, and entitled “Power and/or Alarming Security System for Electrical Appliances”, (2) provisional U.S. Patent Application No. 62/651,598, filed Apr. 2, 2018, and entitled “Power and/or Alarming Security System for Electrical Appliances”, and (3) U.S. patent application Ser. No. 16/117,304, filed Aug. 30, 2018, and entitled “Power and/or Alarming Security System for Electrical Appliances”, published as U.S. Patent Application Pub. No. ______, the entire disclosures of each of which are incorporated herein by reference.

The power module 708 of the modular puck 102 can be configured to accept power from outside sources and transfer such power to the connected electronic product or device. In some examples, the power will flow into the modular puck 102 through one of the interfaces 312 (e.g., connective mount interfaces) and into the internal circuitry of the power module 708. From there, the power levels may be adjusted to transfer the necessary power requirements to the attached electronic product through the cable 130.

The power flowing in the modular puck 102 may be from an alternating current (AC) source. In some example embodiments, the power flowing into the modular puck 102 may be AC power. As the cable input interface 120 of the modular puck 102 may be a USB connection or the like, such an AC voltage must be rectified into an acceptable direct current voltage used by the attached electronic product. Thus, the internal circuitry of the modular puck 102 may have a voltage rectifier to rectify the AC voltage into an acceptable DC voltage. For example, many smartphone devices require a charging voltage of 5 volts direct current. Thus, the voltage rectifier may rectify the incoming AC voltage into 5 volts DC for charging.

In some example embodiments, the power flowing into the modular puck 102 may be DC power. To support the ability to power a serial sequence of multiple modular pucks 102 in the system 100, the amount of power entering puck 102 may be multiples higher than the amount of power needed to operate that particular puck 102 (so that there is also sufficient power to pass to downstream pucks 102). Accordingly, the power module 708 may also include a tap into such a high power line and voltage drop circuitry that reduces the drawn power for the subject puck 102 to a level needed by the subject puck 102.

While some electronic products require 5 volts DC, other electronic products which may be attached to the modular puck 102 may require slightly different voltages (i.e. 5.1 volts DC) to provide the optimal charge. Thus, the internal circuitry can also include a voltage regulator to stabilize the incoming power to the optimal charging voltage. In such embodiments, this gives the modular pucks 102 the ability to connect to a multitude of different electronic products which may require a vast range of different voltages. Connection of the electronic product to the modular puck would allow the circuitry of the modular puck 102 to determine such requirements.

Returning to the security module 702, the circuitry of the modular puck 102 may also continuously and/or periodically measure current drawn by each device plugged into the cable input interface 120 and may enunciate an alarm or other type of indication if these characteristics deviate significantly from a set point. Most electronic products will charge at a quicker rate based on the amount of current being delivered to the product. However, if too much current is passing to the electronic product, the electronic product may fail or burn out. In some embodiments, the circuitry of the modular puck 102 can limit the current levels passing to the electronic product within a 500 mA to 2000 mA range. For specific electronic products such as smartphones, a 5 v DC connection at 2000 mA may provide the ideal conditions for a quick charge time of the attached electronic product. Furthermore, the current regulation circuitry may employ the charge management techniques described in provisional U.S. Patent Application No. 62/643,579, filed Mar. 15, 2018, entitled “Intelligent Battery Management”, the entire disclosure of which is incorporated herein by reference, in order to avoid overly charging a battery on the connected electronic device.

In order to monitor current draw and define set points for triggering alarms, at least in particular example embodiments, two basic phases of operation occur. A first is phase comprises a calibration phase, and the second phase may comprise a monitoring phase. During the calibration phase, for example, the circuitry may characterize the device attached to the cable input to determine the general current characteristics of the device so that an appropriate alarm threshold can be determined for each device. After each device has been characterized and the alarm criteria and/or thresholds have been determined, the monitoring phase in entered. In the monitoring phase, the same circuitry of each modular puck 102 is used to continuously monitor each cable connection through the cable input interface 120 for changes and/or trigger an alarm if the limits set in the calibration phase are exceeded. Examples of circuitry that can be used for such calibration and monitoring of electrical characteristics at cable input interface 120 are described in the above-referenced and incorporated 62/553,770, 62/651,598, and Ser. No. 16/117,304 patent applications.

For example, according to an example embodiment, sensor circuits may be utilized within the modular puck's circuitry. In particular example embodiments, there may be a single sensor circuit for each modular puck 102. The sensor can be a custom design at least in particular example embodiments. This may comprise a purely analog circuit that stimulates the electronic product connected through the cable input interface 120, and/or amplify the response received so that it can be converted to the digital domain and/or processed. However, in other example embodiments, the sensor may comprise a digital circuit.

In other embodiments, the internal circuitry of the modular puck 102 may have a current sensor. This current sensor may be used to measure the current exiting the modular puck 102 through the attached cable 130. For example, the current may be measured across a sense resistor which is in series with the neutral line of the cable input. Additional resistors may set the gain to an amplifier which multiplies the result up to the appropriate input level with the help of transistor amplifiers.

The current measurement circuit can be triggered by a DSP processor at a known phase with an AC line (for embodiments where AC power may be entering the modular puck 102). It can make a series of measurements at precise times for 100 ms. This can capture both the magnitude and the phase of the current so that reactive and/or resistive loads can be differentiated. The raw measurements are corrected for known phase delays in the circuit to present an accurate representation of the magnitude and/or phase of the current drawn by the electronic product connected to the modular puck 102.

In other embodiments, a DSP block may be present within the modular puck 102 and be responsible for generating stimulus to the sensors and/or processing the response received back from the sensors. It is implemented in an FPGA to provide sufficient processing power and speed while exhibiting acceptable costs. All such functions can be implemented in synthesizable RTL code.

The internal circuitry of the modular puck 102 may also provide for current testing. For current measurement, the DSP generates multiple measurement triggers (e.g, five measurement triggers) over a defined time period such as over 100 milliseconds. These triggers span 6 cycles at 60 Hz or 5 cycles at 50 Hz. These triggers can be generated at precise phase shifts from the line power that is delivered to each of the modular pucks 102. The resulting measurements represent the current at those precise phase delays relative to the main power. The DSP circuit then computes the average magnitude and/or relative phase of the measured current to the main's voltage.

Current measurements may be performed with a signal trigger request from a processor such as a microprocessor (MCU) which may be contained within each modular puck 102. The MCU requests a current measurement from the DSP. The DSP arms and waits for the next cycle of the mains power to trigger it. Once it receives the trigger, the DSP makes its five measurements, averages the results, and/or provides a complex current value representing magnitude and/or phase back to the MCU on completion.

In some embodiments, the MCU controls the user interface, but also performs two roles in the modular puck 102. The first is calibration, and second is alarm generation. The sensor and DSP provide real time data on the status of the loads of the cable input interface 120, they do not do any limit checking of those results. All limits for alarm conditions are determined and monitored by the MCU. Any disconnect from the modular puck 102 at any point can generate an alarm unless prior authorization is obtained from the control module 106. The current of the connected electronic product may be unique for each device, or class of devices.

To support a wide range of devices, a two stage calibration process can be employed as described in the above-referenced and incorporated 62/553,770, 62/651,598, and Ser. No. 16/117,304 patent applications. This calibration process gathers data on the current under different conditions and uses it to set the alarm thresholds for each connected device. If there is current and it does not change from the first to the second measurement then it is assumed to have static power.

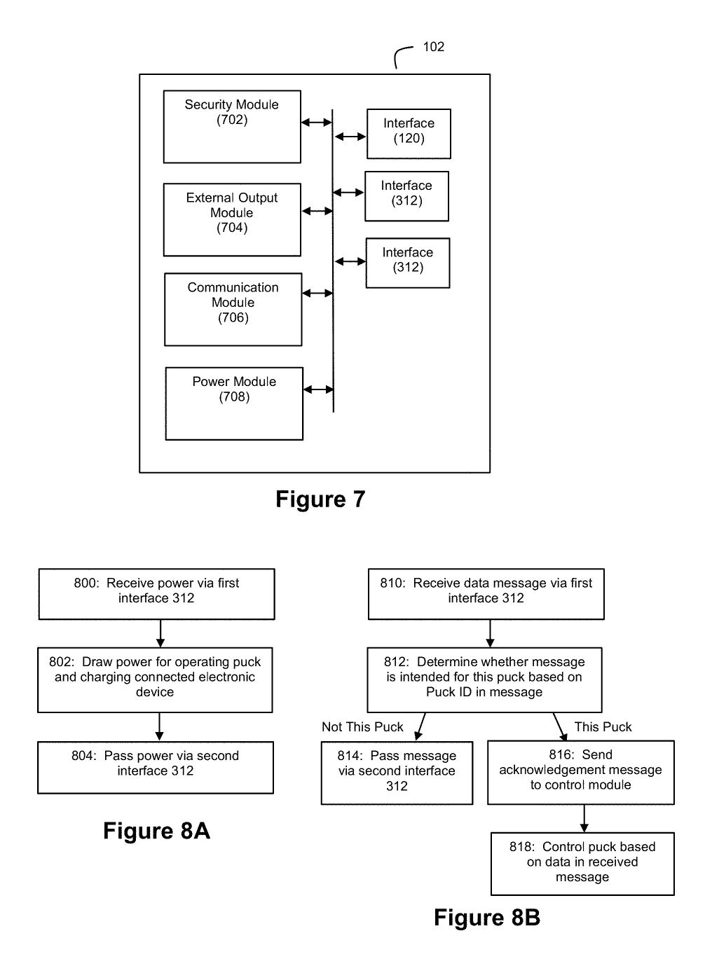

Returning to FIG. 7, the modular puck's circuitry can also include a communication module 706. Communication module 706 can provide power and data taps for the puck 102 (and its connected electronic device) as well as provide a pass-through for relaying power and data to upstream or downstream components of the system (e.g., other modular pucks 102 or control module 106).

FIG. 8A depicts an example process flow for a power communication aspect of the communication module 706. At step 800, the puck 102 receives power via one of the interfaces 312. At step 802, the puck 102 draws from this received power to obtain power for operating the puck 102 and charging the connected electronic device. As noted above, voltage and current regulation circuitry can be employed as part of this step. At step 804, the puck 102 outputs and relays the remaining power via the other interface 312. In this way, communication module 706 can both tap into received power for operating the puck 102 and also pass through received power to downstream components of the system 100.

FIG. 8B depicts an example process flow for a data communication aspect of the communication module 706. At step 810, the puck 102 receives a data message via one of the interfaces 312. This data message may contain data such as an operating status, alarm status, activity status, connected electronic device status, etc. about another modular puck 102 in the system 100. This data message may also contain a request for such information about the subject puck 102 or another modular puck 102 in the system 100 or it may contain a request to change an operating status for the puck 102 (e.g., arm or disarm a puck, silence an alarm, etc.). Each modular puck 102 can be associated with a puck identifier that serves to identify the subject puck 102 within system 100. The puck identifiers can then serve as addresses for the pucks 102 within the system. The control module 106 may also be associated with a control module identifier that serves as an address for the control module 106 within the system. Data messages may then include source addresses and destination addresses that identify which components of the system 100 such messages are directed to. At step 812, the communication module 706 determines whether the received message is intended for the subject puck 102 based on the puck identifier in the received message. If step 812 results in a determination that the message was not intended for the subject puck 102, then the process flow proceeds to step 814 where the communication module 706 outputs the message via the other interface 312 to relay the message along within the system 100. If step 812 results in a determination that the message was intended for the subject puck 102, then the process flow proceeds to step 816. At step 816, the communication module may send a receipt acknowledgement to the sender (e.g., control module 106). Also, at step 818, the puck 102 can then extract data from the message and control the puck 102 in response to the extracted data from the message. For example, if the received message was a command from the control module 106 for the subject puck 102 to disarm itself, step 818 can results in the subject puck 102 controlling the security module 702 for the subject puck 102 to enter a disarmed mode. Step 818 can also result in the puck 102 generating a message that it transmits to the control module 106 via one of the interfaces 312. Such a message can include the identifier for the subject puck 102 so that the message has a source identifier for use by the control module 106. As examples, the data message might include status information about the puck 102 or connected electronic device in response to an incoming message from step 810 that served as a request for such status information.

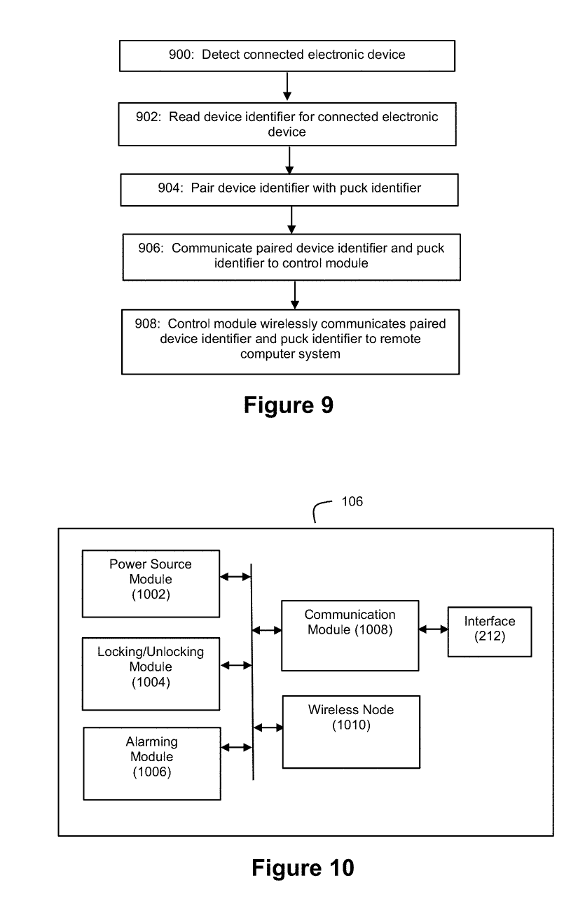

FIG. 9 shows an example process flow for a modular puck 102 with respect to obtaining and relaying information about a connected electronic device via communication module 706. At step 900, the puck 102 detects a connected electronic device at cable input interface 120. At step 902, the puck 102 reads the device identifier for the connected electronic device. This device identifier can take any of a number of forms, such as a make/model/serial number for a smart phone or other identifying information.

At step 904, the puck 102 pairs the device identifier with the puck identifier for itself. This pairing can provide knowledge for the system or retail environment as to which devices are connected to which pucks 102. At step 906, the puck 102 communicates the paired device and puck identifiers as a message to the control module 106 via one of the interfaces 312. This message may then be relayed via connective module 104 and possible one or more other modular pucks 102 to the control module 105 (see, e.g., the pass through flow of FIG. 8B). At step 908, the control module 106 receives this message and may wirelessly communicate the paired device and puck identifiers to a remote computer system to allow the remote computer system to track which devices are connected to which pucks 102 within the system 100 or retail environment. Examples of technology that can wirelessly link a control module 106 with a remote computer system are described in U.S. Patent Application Publication Nos. 2017/0164314, 2018/0007648, 2018/0288720, 2018/0288721, and 2018/0288722, the entire disclosures of each of which are incorporated herein by reference.

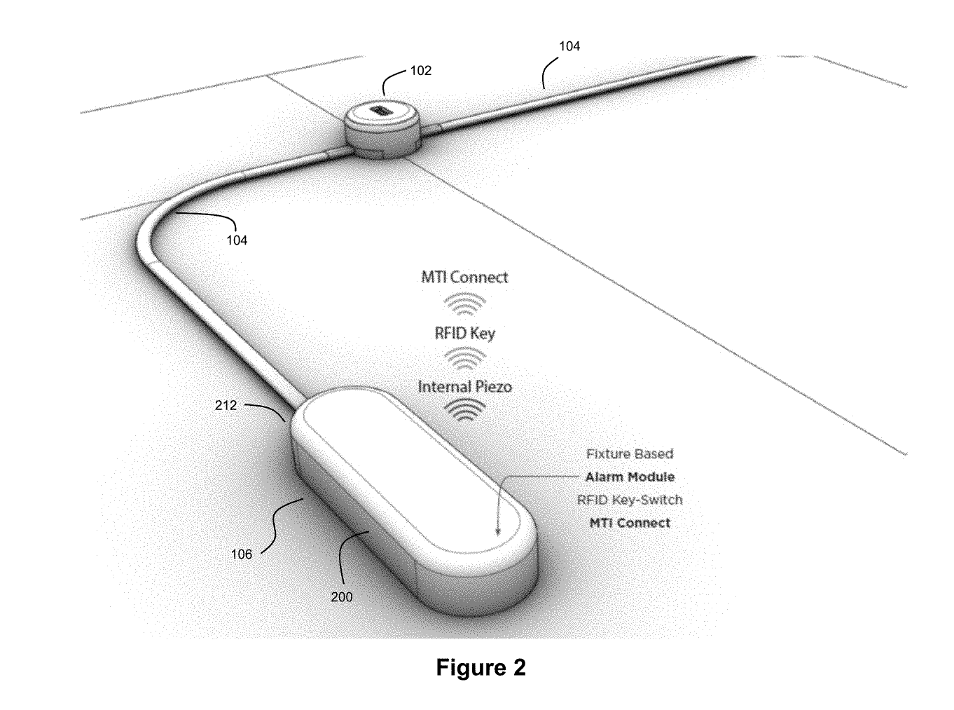

Turning now to FIG. 2, the control module 106 is viewed. The control module 106 can be connected to a modular puck 102 through a connective module 104. In many instances, the control module 106 may be a multipurpose module which can house many internal electronic components to operate the modular retail security system 100. As shown by FIG. 10, these components may include a power source module 1002, a locking/unlocking module 1004, an alarming module 1006, and/or an inter-connective communication module 1008, each contained within the multipurpose control module 106. Furthermore, the control module 106 may also include a wireless node 1010 for wireless connectivity with a remote computer system. This wireless connectivity can use the techniques and provide functionality described by the above-referenced and incorporated U.S. Patent Application Publication Nos. 2017/0164314, 2018/0007648, 2018/0288720, 2018/0288721, and 2018/0288722.

With reference to FIG. 10, the control module 106 may include a power source module 1002. Although not shown within FIG. 10, the control module 106 may have a connected plug and cord to electronically attach the control module 106 to an outside power source to provide power to the overall modular retail security system 100. This connection can be made through power source module 1002. In some embodiments, a battery may be located within the power source module 1002 to provide the control module 106 with power in case of a power disruption or outage from the main power source. This would allow the control module 106 to continue to act as a security system in such situations where power disruption occurs. In other embodiments, each modular puck 102 may also have a battery to power each modular puck 102 individually to help bear the power load during an outage. In other instances the power source module 1002 may be a separate standalone unit and act as a connective module 104 to attach either to the control module 106 or a modular puck 102 to provide the power to the modular retail security system 100.

Like the modular pucks 102, the control module 106 may have a housing 200 (see FIG. 2) to contain the control module's internal electronic circuitry. The housing 200 may be made of any type of durable material so that simple jostling or movement of the housing 200 will not break or allow the housing 200 to dislodge from the control module's current position in a retail environment. For example, the housing 200 may be made of durable plastic polymer materials, but it should be understood that other materials of substantial structural strength may also be used.

The control module 106 may also contain at least one interface 212. The interface 212 can be similar in nature to interfaces 312 of the modular pucks 102. The interface 212 provides an interconnection for the control module 106 with the remaining components of the modular retail security system 100 through connective members 104. In situations where there are multiple modular pucks connected in series to the interface 212, the interface 212 can multiplex power and data for distribution to the different modular pucks in the series via the connective cable 104. The control module 106 may have a similar cutout portion of a similar semi-circular design like the modular puck 102 (e.g., see FIG. 3) such that a connective module 104 may connect to the control module 106 to give the control module 106 an appearance of an uninterrupted control module.

Within the control module 106, as stated above, internal circuitry is present for multiple other modules. The internal circuitry may include corresponding hardware such as microprocessors, buses, memories, and networking interfaces to communicate and execute commands between the various modules of the control module and overall modular retail security system. As shown by the example of FIG. 10, one of these module systems may be an alarming module 1006. The alarming module 1006 may have an audible buzzer or piezo alarm which may be activated upon the removal of a cable 130 connecting one of the electronic products to an individual modular puck 102. The audible buzzer may be powered by either a battery contained within the control module 106 or the overall power traveling into the control module 106 from an external power source. The alarming module 1006 can also trigger an alarm such as an audible buzzer or piezo alarm in response to an electronic device being disconnected from its connecting cable 130 when its corresponding puck 102 is armed. The alarming module 1006 can also trigger an alarm such as an audible buzzer or piezo alarm in response to a connective module 104 (with connected modular puck 102) being disconnected from the system 100 when the system 100 or connected modular puck 102 is armed. Data messages indicative of such alarm conditions and/or sense loops can be employed within system 100 for the control module 106 to detect the existence of alarm situations and decide whether to trigger an alarm.

The control module 106 may also have a locking/unlocking module 1004 within the internal circuitry of the control module. The locking/unlocking module 1004 can provide access control for users with respect to system 100 such as arming and/or disarming the system 100 (or individual pucks 102), locking or unlocking the availability of certain functions for the system 100 (or individual pucks 102), etc. Examples of technologies that can be used to implement and support the locking/unlocking module 1004 are described in U.S. Patent Application Publication Nos. 2017/0300721 and 2017/0301199, the entire disclosures of each of which are incorporated herein by reference. For example, this locking/unlocking module 1004 may take on the form of a RFID reader within the control module 106, although it should be understood that other techniques for reading the credentials of users can be used such as near field reader technology may be used to achieve the same function. When a user approaches the control module 106 with a RFID identification device, such as a card or other form of security fob, the user may bring the identification device near the control module 106. If the control module 106 recognizes the identification device as belonging to an authorized user, the RFID reader may cause the control module 106 to transmit an access authorization command such as a locking or unlocking command to the modular pucks 102. In other instances the RFID reader my cause the control module 106 to transmit an access authorization command such as a locking or unlocking command to a specific modular puck 102 of the modular retail security system 100 based on a modular puck identifier either contained within the identification device, the RFID reader or a remote compute system communicating with the control module 106. In these instances, a device identifier from the attached electronic device to a modular puck 102 may also be used to arm/disarm the security of the respective modular puck 102. Once the alarm thresholds are set, the control module 106 can be armed, and it will continuously monitor all connected modular pucks 102 and all the connected devices present when the modular pucks 102 were calibrated. An audible and/or visible alarm may be generated if the alarm conditions set for that an individual puck 102 are met. The alarming module 1006 has the ability to generate alarms based on modular puck fault, over current to a modular puck 102, loss of power to a modular puck 102, or removal of the cable 130 connecting the electronic product to a modular puck 102. Each alarm condition has a unique signature within the circuitry of the system 100. The RFID reader of the control module 106 can then be used to arm, disarm, and/or silence alarms. The RFID reader can also be used to initiate a calibration sequence in the event the individual modular pucks 102 are remerchandised.

The RFID identification device or similar products (such as other forms of security fobs) may have an identifier for a particular user. The addition of an identifier to an authorization list can be referred to as “whitelisting” the RFID identification device corresponding to that identifier. An example procedure and corresponding technology for performing the whitelisting can rely on a timed sequence of interactions between RFID identification devices and a remote computer system are described in the above-referenced and incorporated U.S. Patent Application Publication Nos. 2017/0300721 and 2017/0301199.

When a whitelisted or authorized RFID device is determined by the RFID reader, the locking/unlocking module 1004 may request authorization from a computer system. This authorization request can include an identification of the RFID device's identifier. The computer system reads the RFID device's identifier and checks the identifier against the authorization list. If the RFID device is on the authorization list, then, in an example embodiment, the RFID device can be authorized to transmit a security code that causes an arming/disarming of the modular puck's security circuitry. If the subject RFID device is not on the authorization list, then no authorization is given. Software contained within the memory of the control module 106 may be executed by a processor of the control module 106 to facilitate such an authorization arrangement. The process begins when the RFID device interfaces with the control module 106 via an interface such as an RFID reader. If there is a connection between RFID reader and the RFID device, the RFID device can receive operating power from the control module via the connection. Using such operating power, the processor of the control module 106 and the RFID device can wake up and execute their respective software programs for communication with the remote computer system for the whitelisting action. However, this is only an example, and other techniques such as different techniques described in the above-referenced and incorporated U.S. Patent Application Publication Nos. 2017/0300721 and 2017/0301199 can be used to authenticate user authorization credentials such as security fobs that may be presented to the control module 106.

The control module 106 may also contain an inter-connective communication module 1008. The inter-connective communication module 1008 may communicate through the connective modules 104 with the attached modular pucks 102 via interface 212. In some embodiments, a device identifier of the attached electronic device can be transmitted to the modular puck 102 through the cable 130 and then on to the control module 106 via the inter-connective communication module 1008 (see, e.g., FIG. 9). From here, the inter-connective communication module 1008 can interact with wireless node 1010 to transmit the device identifier to a remote computer system to track and verify the connection of the device to a particular modular puck 102 within the retail environment.

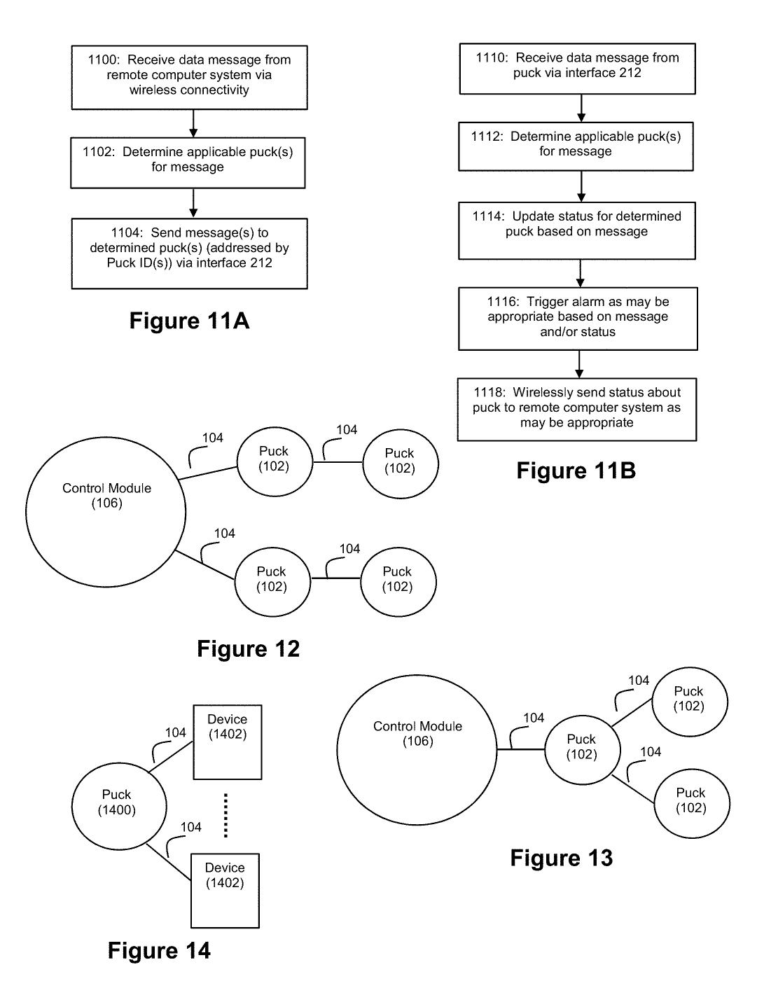

Communication module 1008 can also employ process flows similar to those of FIGS. 8A and 8B to manage the transfer of power to the attached modular pucks 102 via interface 212 and connective modules 104 as well the transfer of data with respect to the attached modular pucks 102 via interface 212 and connective modules 104. FIG. 11A shows an example of how a control module 106 may send a data message to a modular puck 102 in response to a message from a remote computer system. FIG. 11B shows an example of how a control module 106 may receive and process a data message from a modular puck 102.

With reference to FIG. 11A, at step 1100, the control module 106 receives a data message from a remote computer system via the wireless node 1010. At step 1102, the control module 106 determines an applicable puck 102 for the received message. For example, the received message may request the status of the device connected to a particular puck 102, in which case the message may include an identifier for the subject puck 102 or the subject device. At step 1104, the control module 106 then sends a message to the determined puck 102 via communication module 1008 and interface 212. This message can be addressed to the determined puck 102 via the puck identifier for that determined puck 102. Also, step 1102 resulted in a conclusion that multiple pucks 102 are applicable to the received message, then step 1104 can result in messages being sent to each of those pucks 102 (via addressing specific to those pucks 102).

With reference to FIG. 11B, at step 1110, the control module 106 receives a data message from a puck 102 via interface 212. At step 1112, the control module 106 determines the applicable puck for the received message. This determination can be made based on a source puck identifier that is included in the message. At step 1114, the control module 106 extracts content from the message and updates a status in memory for the determined puck based on the extracted content from the message. For example, if the message includes a flag that the subject puck 102 in an alarm condition, the control module 106 can update its logged status for the puck to indicate the existence of this alarm condition. As another example, if the message includes data that identifies a device identifier for an electronic device that has been newly connected to the subject puck 102, the control module 106 can update a data table for the system 100 to record the device identifier that has been paired with that puck. At step 1116, the control module 106 may trigger an alarm as may be appropriate based on the content of the message and updated puck status from step 1114. At step 1118, the control module 106 may wirelessly send the updated status information about the subject puck 102 to a remote computer system via wireless node 102. The remote computer system can then update its records about system 100 accordingly.

As noted above, wireless node 1010 can provide wireless connectivity for the control module 106 with one or more remote computer systems. Through such connectivity, the remote computer system can monitor and track which electronic devices are connected to which modular pucks 102 (see, e.g., FIG. 9) via the pairing and sharing of device identifiers and puck identifiers. As indicated, a device identifier may, for example, thus be capable of identifying a particular device, slotting position within a retail display, shelf, etc., locating a mobile node, device, etc. within a mobile environment, locating a new node entering into a network, or the like, or any combination thereof. For example, in some instances, a node identification function and/or process may make use, at least in part, of the device's identifier. In this context, “the device identifier” refers to one or more attributes related to and/or representative of a particular device with the modular puck 102 that a computing platform and/or device may use, in whole or in part, to electronically identify such a device.

A device identifier may, for example, be assigned to and/or associated with modular puck 102 via any suitable approach. For example, at times, a device identifier may be assigned to a particular electronic device (e.g., smart telephone, etc.) by a product manufacturer (e.g., Apple, Inc., etc.), service provider (e.g., Verizon® Wireless, etc.), global decimal administrator (GDA), etc., and/or may be associated with a corresponding modular puck 102, such as by a system administrator, retailer, entity, etc. A device identifier may include any suitable letter, numeral, symbol, image, etc., or any combination thereof, and may comprise and/or be represented, at least in part, via a numeric, alphabetic, alphanumeric, symbolic, semiotic, etc. representation, such as a number, code, name, symbol, or the like. Thus, as a way of illustration, a device identifier may, for example, comprise and/or be represented, at least in part, via an International Mobile Subscriber Identity (IMSI), an Integrated Circuit Card Identity (ICCID), an International Mobile Equipment Identity (IMEI), a Mobile Station Integrated Services for Digital Network number (MSISDN), a model, a type, a make, a barcode, a universal product code (UPC), a serial number, software parameters, hardware parameters, a location, or the like, or any combination thereof.

For example, the electronic product may communicate a device identifier, which may comprise its assigned IMEI or like number, if applicable, to the modular puck 102 via the cable input 130, or like protocol, such as upon being connected to modular puck 102 (e.g., see step 902 of FIG. 9). The device identifier may, for example, be used, to determine a location of the node within a particular environment, such as a slotting position within a retail display, retail store, shelf, wall, or the like. For example, a location of an electronic device may be determined, at least in part, via associating or linking its device identifier with a pre-defined or prescribed slotting position within a retail display, shelf, store, etc. A location of an electronic device may, for example, be determined, at least in part, in relation to a global coordinate system, local coordinate system, or any combination thereof. A global coordinate system may comprise, for example, a coordinate space mapped according to a global reference frame, such as Earth-centered coordinates (e.g., latitude, longitude, etc.). A local coordinate system may comprise, for example, a coordinate or other (e.g., logical, etc.) space not mapped according to a global reference frame. As such, a local coordinate system may comprise, for example, any suitable system capable of facilitating and/or supporting location determination with respect to a wireless node. For example, in some instances, a location of an electronic product may be determined, at least in part, with reference to a space mapped according to a store such as a slotting position within a retail display, shelf, wall, etc. At times, a location of an electronic product may comprise a point or like element, such as in a physical and/or logical space, for example, determined via referencing some other point or like element (e.g., Node 2 is located immediately to the right of Node 1, etc.), device (e.g., iPhone® 7 is next to Samsung® Galaxy Note 7, etc.), slotting position (e.g., Node 3 is at display position 5, etc.), or the like. In some instances, a location of an electronic product may comprise, for example, a point or like element mapped to a floor plan of a retail store, just to illustrate another possible implementation. The nodes in such scenarios may be represented by the modular pucks 102 to which the electronic products are connected.

As indicated above the device identifier may be received by the control module 106 via interface 212 and communication module 1008, and then communicated to a remote computer system via wireless node 1010. The remote computer systems may include a database, which may comprise, for example, any suitable information repository capable of storing or otherwise retaining information, which, at times, may be in the form of binary digital signals, just to illustrate one possible implementation. For example, the database may store binary digital signals comprising attributes related to one or more device identifiers such as statistical attributes, identifying attributes, security attributes, operational attributes, or the like, or any combination thereof. Statistical attributes may comprise, for example, information regarding a number of time a particular electronic device (e.g., smart telephone, etc.) has been lifted or picked up by a customer, a duration of a particular lift, a number of modular pucks within the retail environment, a number of alarm events (e.g., theft attempts, etc.), a number of times a particular electronic product has been accessed (e.g., by store personnel, etc.), activated, (e.g., a modular puck has been locked, unlocked, etc.), non-compliant, etc., information regarding a movement of an electronic product within a network, whether a device associated with a modular puck is on or off, or the like, or any combination thereof. Identifying attributes may comprise, for example, information regarding a device model, type, make, etc., modular puck address (e.g., local, global, etc.), device's identifier or display position, power status, software version, manufacturer, or the like, or any combination thereof. Security attributes may comprise, for example, information regarding whether the electronic device is currently armed or disarmed, a number of times an electronic device has been armed and/or disarmed, whether a modular puck is alarming (e.g., a cable has been cut or removed, theft attempted, etc.), whether alarms are functioning properly, a version of a security system (e.g., age, date of sale, type, etc.), or the like, or any combination thereof. Operational attributes may comprise, for example, information regarding whether a device is charging, whether the modular retail security system, or any part of thereof, is powered correctly, devices are imaging properly, whether operation-related data is being communicated appropriately, or the like, or any combination thereof. The above-referenced and incorporated U.S. Patent Application Publication Nos. 2017/0164314, 2018/0007648, 2018/0288720, 2018/0288721, and 2018/0288722 describe examples of the system 100 can be remotely monitored and controlled via such a remote computer system (e.g., via user interfaces that may visualize and present status information about the pucks 102 and/or connected electronic devices within system 100).

Turning now to FIG. 3, an aspect of the assembly of the modular retail security system 100 is shown. As stated above, the modular pucks 102 are designed to work and attach in connection with connective modules 104. When assembled piece by piece, the combined product is viewed as the modular retail security system 100. In FIG. 3, two connective modules 104 are viewed on either side of a modular puck 102. The connective modules 104 are shown as connective cables. The bottom face 310 of the modular puck 102 is clearly viewed. Here, the plurality of cutouts 114 and 116 can be seen where the connective modules 104 will fit into the modular puck 102 to form and uninterrupted design of the modular puck 102 to an outside viewer. Within each of the cutouts 114 and 116, a connective mount interface 312 is shown. The connective mounts of interfaces 312 accept raised connectors 322 on each end 320 of the two connective modules 104. In the example embodiment of FIG. 3, the design of these connective mounts for interfaces 312 is a six pin female design. A corresponding six pin male design is shown for connectors 322 on ends 320 of the connective modules 104. When the modular puck 102 is lowered onto each of the connective modules 104, the modular puck 102 is secured by the connection of the raised connectors 322 inserted into the connective mounts of interfaces 312. These connections allow for data information transfer and power transfer between the modular puck 102 and the connective modules 104 and thus provide a flow path to any other outside connected modular pucks 102, control module 106, or other components of the modular retail security system 100.

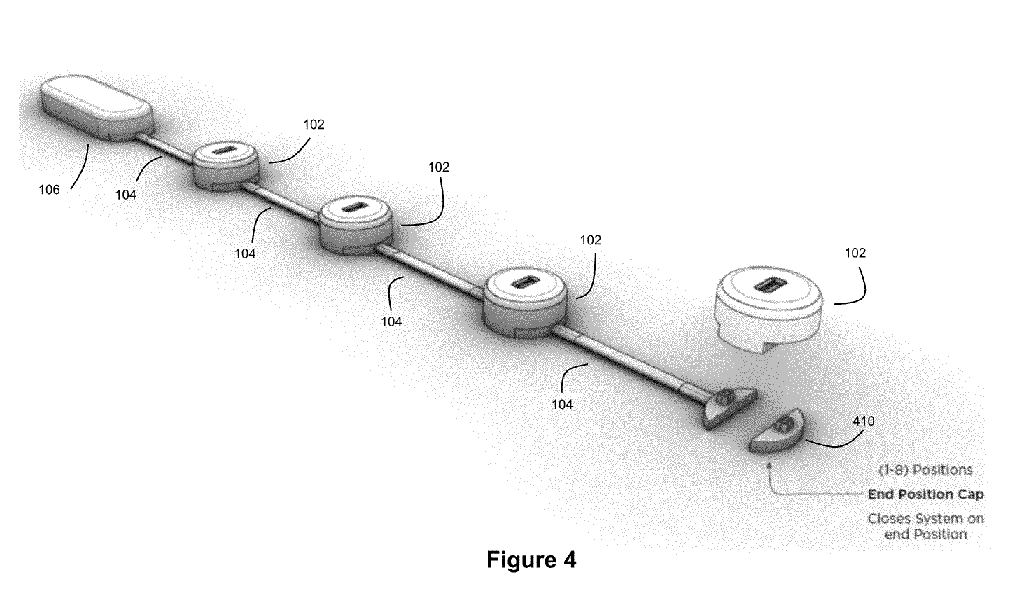

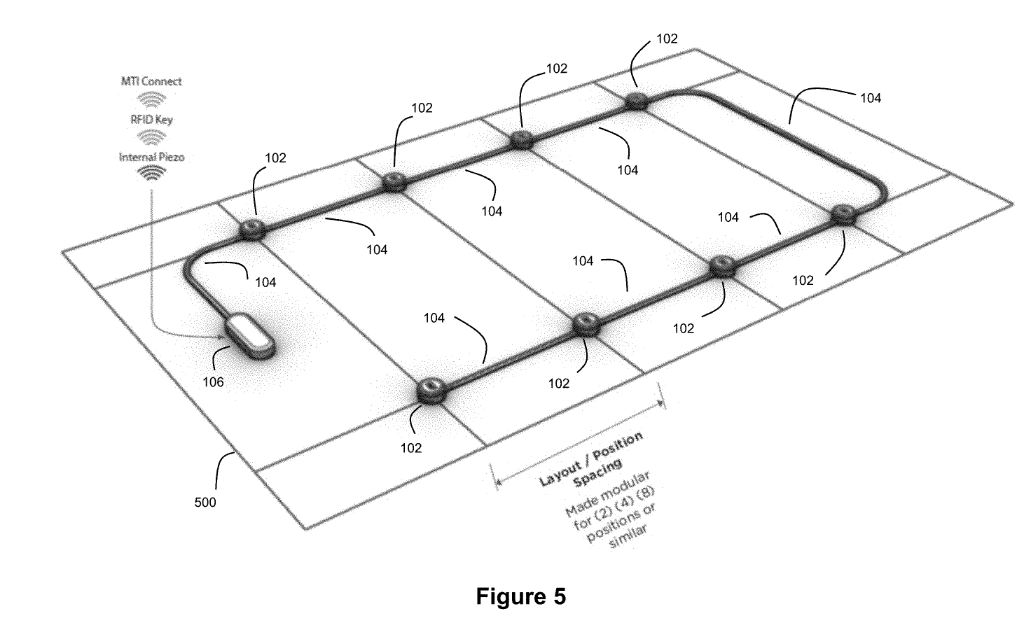

In the example of FIG. 3, the durability of the connection between 312 and 322 is enhanced because the plane of connection between 312 and 322 is effectively orthogonal to the likely direction of pulling forces that might be applied to the pucks 102 when used within system 100. That is, if the system 100 is deployed such that the pucks 102 are laid out as a serial string on a table (e.g., see FIGS. 4 and 5), it may be the case that a person will pull on one of the pucks 102 in the string. But, because the plane of connection between 312 and 322 will largely be perpendicular to the predominant force direction of such pulling actions, the integrity of the connection between 312 and 322 is likely to be maintained. However, it should be understood that some practitioners may choose to orient the connective mount of interfaces 312 and the connectors 322 of the ends 320 of connective modules 104 in different manners that need not be orthogonal to the lateral pulling force. For example, interface 312 can be located on a sidewall of housing 108 for the pucks 102 rather than on the bottom, and the connectors 322 can extend outward from the axis of connective modules 104 if desired. If a practitioner wished to enhance the durability of connections in such a design, then other techniques for interlocking the connections between interfaces 312 and 322 could be employed.

In FIG. 4, a linear design of the modular retail security system 100 is viewed where the pucks 102 are connected in series. Furthermore, the design of a few of the different types of connective modules may be seen. One type of connective module can be a connective cable module as denoted by 104 in FIG. 4. The connective cable may have a first longitudinal end and a second longitudinal end. At each longitudinal end the connective cable module has a semi-circular design to fit within an attachable module (e.g., see 320 in FIG. 3). This attachable module may be a modular puck 102, a control module 106, or any other foreseeable module having an acceptable cutout portion to accept the connective cable module 104. At each longitudinal end of the connective cable module 104 a raised connector 322 may be present as shown by FIG. 3. These raised connectors insert into the connective mounts of interfaces 312 or 212 located on the attachable modules. The connective cable module 104 may also have a casing between the two longitudinal ends. This casing protects a plurality of wires which are enclosed within the connective cable module 104 and run from each of the raised connectors 322. This plurality of wires allows for the transfer of data/information and power between the interconnected components of the modular retail security system 100. Additionally, the casing of the connective cable modules 104 can be flexible in nature. Thus, the connective cable modules 104 may run in non-linear formations within the retail environment so that the modular pucks 102 may be adjustably positioned based on the user's needs. Although the connective cable modules 104 of FIG. 4 are shown as having similar lengths, it should be understood that the connective cable modules 104 can be manufactured to any desirable length based on the needs of the user of the modular retail security system 100.

Also viewed in FIG. 4 is an end cap module 410. The end cap module 410 can be an inactive module which may connect to the last attachable modular puck 102 of the modular retail security system 100. In the example of FIG. 4, four modular pucks 102 are present. As the modular retail security system 100 only uses four modular pucks in this example embodiment, the fourth modular puck 102 could be unstable within the retail environment based one of its plurality of cutout portions being unconnected to another cable 104. Thus, end cap module 410 may be placed in the non-active cutout of the final modular puck 102 in the sequence to balance the design of the modular retail security system 100 and support the final modular puck so that is will not become dislodged from the connective module in the other cutout (which is needed for data/information and power transfer). The end cap module 410 can include a raised connector like the connective cable module 104. With reference to FIGS. 3 and 4, the end cap module 410 can fit its male raised connector into the female connective mount of interface 312 to secure the end cap module 410 to the modular puck 102.

FIG. 5 shows an example non-linear layout of the modular retail security system 100 where there are 8 modular pucks 102 connected in series via connective modules 104. As stated above, the connective modules 104 can be manufactured to be flexible. Thus, a user may set up the modular puck locations for each of his or her desired display products in any type of arrangement within the retail environment. Then, during assembly, the user may manipulate and attach corresponding connective modules 104 of appropriate lengths to meet the layout needs for his or her retail environment. This layout may be viewed on top of a retail shelf within the retail environment, or for added security, this layout may be contained below or within the interior of the retail shelf. Although not present within this layout, it should be understood that a power module may connect to at least one of the modular pucks 102 or the control module 106 to provide overall power to the entire modular retail security system 100.

Finally, FIG. 6 shows a linear layout of the modular retail security system with four modular pucks 102 connected in series. This linear layout can have the same assembly and components described in the above sections of the application. FIG. 6 also shows the different color profiles which may be employed by the light ring 112 of each individual modular puck. The control over the displayed color profiles exhibited by light rings 112 can be implemented by the external output module 704 of the modular puck 102 (see FIG. 7). In each of these, illuminated color profile information regarding the modular puck 102 and connected electronic product may be transmitted back to the remote computer system through the control module 106 for outside monitoring. Monitoring by the control module 106 of the modular retail security system 100 can also occur.

In the first example, the light ring 112 of a modular puck 102 may illuminate to a white color to show that the modular puck 102 is both powered and armed. Thus, removal of the cable 130 from the cable input 120 would cause an alarm such as an audible buzzer alarm within the control module 106 to activate alerting retail employees to an issue of possible theft.

In the second example, the light ring 112 of the modular puck 102 may illuminate to a red color to show that the modular puck 102 is in an alarming state. Here, the cable 130 has been removed from the modular puck 102 freeing the (formerly) connected electronic product or device for possible theft. In this situation, the an alarm such as an audible buzzer alarm can be activated to alert retail employees to the situation to prevent any possible theft of the electronic product.

In the third example, the light ring 112 of the modular puck 102 may illuminate to a yellow color to show that the modular puck 102 is in a communication error state. Here, data/information transfer between either the modular puck 102 and the control module 106 or the modular puck 102 and the connected electronic product has ceased to function properly. By visibly showing this communication error state, a retail employee may address the situation with the modular puck 102 and connected electronic product promptly. In some instances, this may mean removing the modular puck 102 and replacing the modular puck with and new correctly functional unit.

Finally, in the fourth example, the light right 112 of the modular puck 102 may illuminate to a blue color to show that the modular puck 102 is operating in a current limiting over current protection mode. Thus, the internal circuitry of the modular puck 102 may have a functional hardware error where the amount of current passing through the modular puck 102 and into the connected electronic product must be limited to an acceptable charging level to prohibit the burnout or over heating of the connected electronic product. In such instances, the power source may be checked for a quick solution to the problem as well as the cable 130 connecting the electronic product to the modular puck 102. If an internal issue of the modular puck 102 is to blame, the modular puck 102 may be removed from the modular retail security system 100 and replaced with a new properly functioning unit.

While example embodiments discussed above describe serial connections of modular pucks 102 within system 100, it should be understood that alternative arrangements could be employed if desired. For example, control module 106 could include multiple interfaces 212 and corresponding internal circuitry that would all for parallel sequences of one or more modular pucks 102. An example of such an arrangement is shown by FIG. 12 (which shows two parallel sequences of modular pucks 102). The number of interfaces 212 that are included on the control module 106 can be chosen by a practitioner to be a number that is suitable for his or her display goals. As another example, the modular pucks 102 may include more than two interfaces 312, which can allow for branching of modular pucks 102 within a sequence of pucks 102 extending from the control module 106. An example of this arrangement is shown by FIG. 13 (which shows a first modular puck 102 that connects to control module 106 via a first interface 312, connects to a second modular puck 102 via a second interface 312, and connects to a third modular puck 102 via a third interface 312. The number of interfaces 312 that are included on the modular pucks 102 can be chosen by a practitioner to be a number that is suitable for his or her display goals.

Further still, if desired by a practitioner, the functionality of a modular puck 102 can be combined with the control module 106 to yield a modular puck 1400 such as that shown by FIG. 14 that directly controls the security management of one or more connected electronic devices 1402. Moreover, such a combined control module 106/puck 102 as shown by 1400 of FIG. 14 could include multiple interfaces 120 so that multiple electronic devices 1402 can be securely displayed by the combined control module/puck 1400 (see FIG. 14).

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An apparatus comprising:
a modular puck for use in retail security, wherein the modular puck comprises (1) a first interface configured to connect the modular puck with an electronic product, (2) a circuit configured to generate at least one of (i) a signal indicative of an alarm condition in response to an unauthorized disconnection of the electronic product, and/or (ii) a signal indicative of an identifier for the electronic product, (3) a second interface, and (4) a third interface, wherein the modular puck is connectable to a plurality of other modular pucks through the second and third interfaces.

2. The apparatus of claim 1, wherein the modular puck comprises a circuit that provides power pass through between the second and third interfaces.

3. The apparatus of claim 1, wherein the modular puck comprises a circuit that provides data pass through between the second and third interfaces.

4. The apparatus of claim 1, wherein the modular puck comprises a circuit that (1) reads a device identifier of a connected electronic product via the first interface, (2) associates the device identifier with an identifier for the modular puck, and (3) outputs a message via at least one of the second and/or third interfaces, wherein the message includes data indicative of the association of the device identifier with the modular puck identifier.

5. The apparatus of claim 4, wherein the circuit includes operational status information about the connected electronic product in the message.

6. The apparatus of claim 1, wherein the modular puck comprises a circuit that (1) receives a message via at least one of the second and/or third interfaces, (2) determines based on an identifier in the received message whether the received message is for the modular puck, and (3) in response to a determination that the received message is not for the modular puck, outputs the received message via at least one of the second and/or third interfaces.

7. The apparatus of claim 6, wherein the circuit, in response to a determination that the received message is for the modular puck, controls an operation of the modular puck based on the received message.

8. The apparatus of claim 7, wherein the controlled operation comprises an arming or disarming operation for the modular puck.

9. The apparatus of claim 1, wherein the second and third interfaces are arranged perpendicularly from a longitudinal axis of connective cables for connection to the second and third interfaces.

10. The apparatus of claim 1, wherein the first interface comprises a connection of the electronic product via a cable.

11. The apparatus of claim 1, wherein the first interface comprises a USB connection.

12. The apparatus of claim 1, wherein the second and third interfaces comprise connections to a second and a third modular puck via a first connective module and a second connective module.

13. The apparatus of claim 12, wherein the first and second connective modules comprise connective cables.

14. The apparatus of claim 13, wherein the first and second connective cables are flexible.

15. The apparatus of claim 14, wherein the first and second connective cables are of different lengths.

16. The apparatus of claim 1, where the modular puck reads a device identifier for the connected electronic product, and wherein the modular puck outputs the device identifier via the second or third interface.

17. The apparatus of claim 1, wherein the modular puck arms and/or disarms in response to a control signal received through the second or third interface.

18. The apparatus of claim 1, wherein the modular puck further comprises:
a housing having a top face and a bottom face;
a cable input located on the top face of the housing and configured to accept an electronically connectable cable to the housing; and
a circuit contained within the housing, the circuit connected to the cable input to transfer power via the cable input and transfer data via the cable input.

19. The apparatus of any of claim 18, wherein the modular puck has at least one cutout on the bottom face of the housing, the at least one cutoff having at least one of the second and third interfaces, wherein the second and third interfaces comprise a connective mount interface recessed within an interior of the housing, the connective mount interface configured to attach the housing to a plurality of different connective modules.

20. The apparatus of claim 19, wherein the connective mount interfaces are further connected to the circuit to allow the transfer of power and data to and from the modular puck.

21. The apparatus of claim 20, wherein the connective mount interfaces have a pin configuration for the transfer of power and data information to and from the modular puck.

22. The apparatus of claim 18, wherein the housing has a cylindrical shape.

23. The apparatus of claim 18, wherein the plurality of different connective modules include an end cap module and a connective cable module.

24. The apparatus of claim 23, wherein the modular puck is connectable to a control module via one of the second and third interfaces and via a connective module.

25. The apparatus of claim 18, wherein a first end of the electronically connectable cable connects to the modular puck and a second end connects to the electronic product.

26. The apparatus of claim 18, wherein the circuit comprises at least one microcontroller to operate the circuit and facilitate power and data transfer operations between the modular puck the electronic product, and at least one of the second and third interfaces.

27. The apparatus of claim 26, wherein the at least one microcontroller calibrates a voltage level and a current level to flow from the modular puck to the electronic product.

28. An apparatus comprising:
a modular puck for securely displaying an electronic product to customers, the modular puck having (1) a first interface through which the modular puck is connectable with a control module, (2) a second interface through which the modular puck is connectable to another modular puck, and (3) a third interface through which the modular puck is connectable to the electronic product;
wherein the modular puck includes a circuit that triggers an alarm message in response to an unauthorized disconnection of the electronic product from the third interface;
wherein the circuit is further configured to receive power from the control module via the first interface and output portions of the received power via the second and third interfaces; and
wherein the circuit is further configured to bidirectionally communicate messages with the control module via the first interface.

29. The apparatus of claim 28, wherein the circuit is further configured to relay a plurality of messages received from the control module via the first interface out through the second interface.

30. The apparatus of claim 28, wherein the first interface is connectable with the control module via a first detachable cable, wherein the second interface is connectable with the another modular puck via a second detachable cable, and wherein the third interface is connectable with the electronic product via a third detachable cable.
